(19) United States
(12) Patent Application Publication
(10) Pub. No.: US 2009/0181578 A1
(43) Pub. Date: Jul. 16, 2009

(54) CONNECTOR ASSEMBLY

(75) Inventors: SHOU-YI CHEN, Banciao (TW); Cheng-Ting Hsieh, Banciao (TW); Yu-Kai Huang, Banciao (TW); Mei-Chuan Yu, Banciao (TW)

Correspondence Address: T-CONN PRECISION CORP., P.O. BOX 11192, TAIPEI, 10099, omitted

(73) Assignee: T-CONN PRECISION CORP., TAIPEI (TW)

(21) Appl. No.: 12/013,447

(22) Filed: Jan. 13, 2008

(51) Int. Cl. H01R 13/40

(52) U.S. Cl. 439/625

(57) ABSTRACT

A connector assembly and an adaptor for various transmission protocols are disclosed. The connector assembly comprises a hollow casing including terminal sets connected at the upper and lower inner part thereof. The hollow casing is connected to a housing with the fool-proof protrusion positioned respectively at the right and the left side thereof. The housing surrounds the hollow casing. The upper and the lower end of the housing have the elastic plate respectively. The adaptor has a hollow casing with a slot, and the slot has a positioning set. The hollow casing is surrounded by a housing. The positioning set respectively includes the terminal set at the upper and the lower side thereof. Thus one single connector assembly and the adaptor can be applied in various transmission protocols.

### BACKGROUND OF THE INVENTION

1. Field of the Invention

The present invention is related to a connector assembly for various transmission protocols and adaptors.

2. Description of Related Art

Along with the revolution of the digital technology, many electronic appliances can be connected to each other via the connector and adaptors for electrical connection, messages/signal transmission and conversion.

There are several types of connector assembly with different specifications available in the market for applying in different information transmission protocols. To process the information transmission, connector must correspond to each other for electrical connection. The modern electronic devices are all design to be lighter, thinner, shorter and smaller to meet the consumers' requirement, and accordingly, there are adaptors suitable for applying in different transmission protocols to adapt connectors with different specifications.

The most widely used connector of the computer external device for the computer peripheral appliances is USB (universal serial bus). Although the cost is lower, however, the limited transmission speed thereof made the eSATA (external serial advanced technology attachment) to become more popular choice for the high speed information transmission, in order to effectively increase the speed of information processing and transmission. Therefore, the above two types of connectors have it's own practical use.

Accordingly, the present invention combines the terminals with many different transmission protocols into one adaptor to adapt the corresponding connectors with different transmission protocols.

### SUMMARY OF THE INVENTION

The present invention provides a connector assembly and an adaptor for applying in different transmission protocols. According to an embodiment of the present invention, possibility of error during assembling the connector assembly and the adaptor can be effectively reduced.

The present invention provides a connector assembly comprised of a plastic material formed from a plastic injection process. The plastic material is injected into a one-piece hollow casing, wherein the hollow casing comprises an upper portion and a lower portion respectively connecting to a set of terminals. The hollow casing is a fool-proof case including a fool-proof protrusion respectively on the both sides with a housing. The housing comprises an elastic plate respectively on the upper and the lower end. The distal end of the elastic plate comprises a positioning portion. Furthermore, the adaptor is a hollow case comprising a slot. The slot comprises a positioning set. The hollow case is surrounded by a housing. The positioning set comprises a set of terminals positioning at the upper and the lower side. Thus, the connector assembly and the adaptor of the present invention can be applied in different transmission protocols. The accuracy of assembling the connector assembly and the adaptor can be increased.

### BRIEF DESCRIPTION OF THE DRAWING

For a more complete understanding of the present invention, reference will now be made to the following detailed description of preferred embodiments taken in conjunction with the following accompanying drawings.

FIG. 1 is a perspective view of a connector assembly according to an embodiment of the present invention.

FIG. 2 is a perspective view of an adaptor according to an embodiment of the present invention.

FIG. 3A is a perspective view of a connector assembly according to an embodiment of the present invention.

FIG. 3B is an exploded view of a connector assembly according to an embodiment of the present invention.

FIG. 4A is a perspective view of an adaptor according to an embodiment of the present invention.

FIG. 4B is an exploded view of an adaptor according to an embodiment of the present invention.

FIG. 5A is an exploded view of an assembly according to an embodiment of the present invention.

FIG. 5B is an exploded view of the assembly from another angle according to an embodiment of the present invention.

FIG. 5C is a sectional side view of an assembly according to an embodiment of the present invention.

FIG. 6 is a prospective view of a connector assembly according to another embodiment of the present invention.

FIG. 7 is a prospective view of an adaptor according to another embodiment of the present invention.

FIG. 8A is a perspective view of a connector assembly according to another embodiment of the present invention.

FIG. 8B is an exploded view of a connector assembly according to another embodiment of the present invention.

FIG. 9A is a perspective view of an adaptor according to another embodiment of the present invention.

FIG. 9B is an exploded view of an adaptor according to another embodiment of the present invention.

FIG. 10A is an exploded view of an assembly according to another embodiment of the present invention.

FIG. 10B is an exploded view of the assembly from another angle according to another embodiment of the present invention.

FIG. 10C is a sectional side view of an assembly according to another embodiment of the present invention.

FIG. 11 is a prospective view of a connector assembly according to another embodiment of the present invention.

FIG. 12 is a prospective view of an adaptor according to yet another embodiment of the present invention.

FIG. 13A is a perspective view of an adaptor according to yet another embodiment of the present invention.

FIG. 13B is an exploded view of an adaptor according to yet another embodiment of the present invention.

FIG. 14A is an exploded view of an assembly according to yet another embodiment of the present invention.

FIG. 14B is an exploded view of the assembly from another angle according to yet another embodiment of the present invention.

### DETAIL DESCRIPTION OF THE EMBODIMENTS

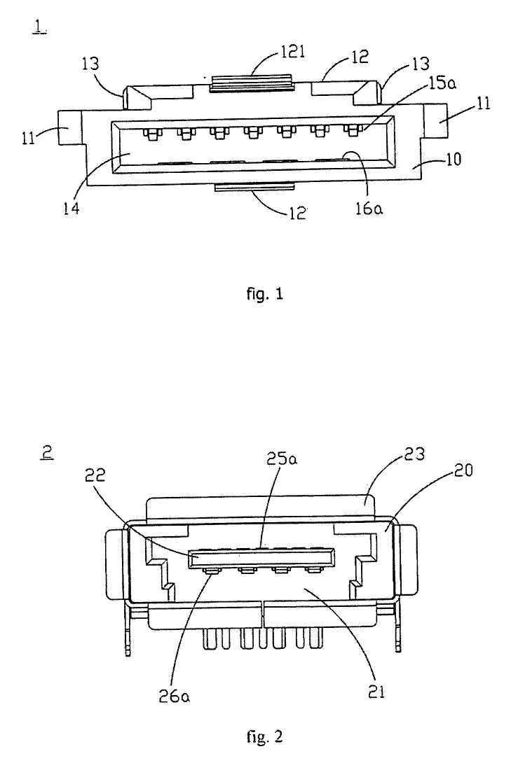

FIGS. 1 and 2 show perspective views of a connector assembly and an adaptor according to an embodiment of the present invention. The connector assembly 1 comprises a hollow casing 10, two fool-proof protrusions 11, a housing 12, two stair-case portions 13, a slot 14, a plurality of eSATA terminals 15a and a plurality of USB terminals 16a.

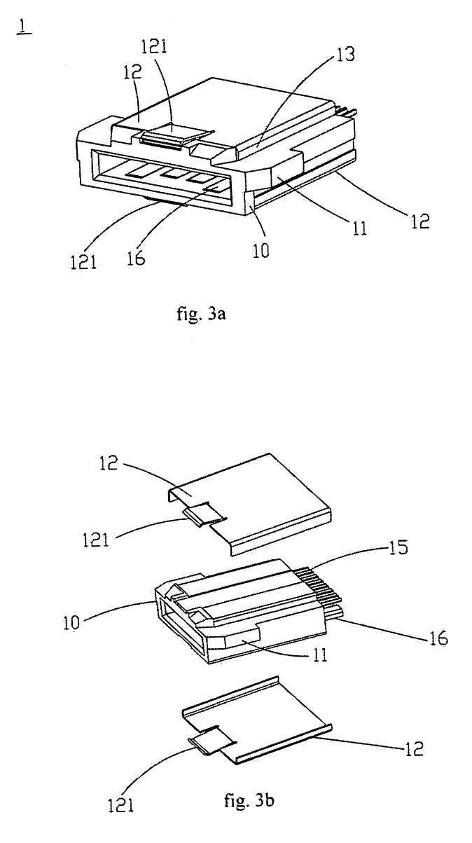

The hollow casing 10 comprises fool-proof protrusions 11 on the two sides thereof, and a housing 12 at the outer side. Referring to FIGS. 3A and 3B, the housing 12 comprises elastic plates 121 positioned at the upper and the lower end thereof respectively. In the present embodiment, the housing is made of a metallic material, and hollow casing 10 can be completely covered by the housing 12, or partially disposed on the upper and the lower end or the right and the left sides.

The slot 14 is positioned at the central region of the hollow casing 10, and the slot 14 comprises an eSATA terminal set 15 comprising a plurality of eSATA terminals 15a. A USB terminal set 16 comprising a plurality of USB terminals 16a is positioned underneath slot 14 corresponding to the eSATA terminal set 15.

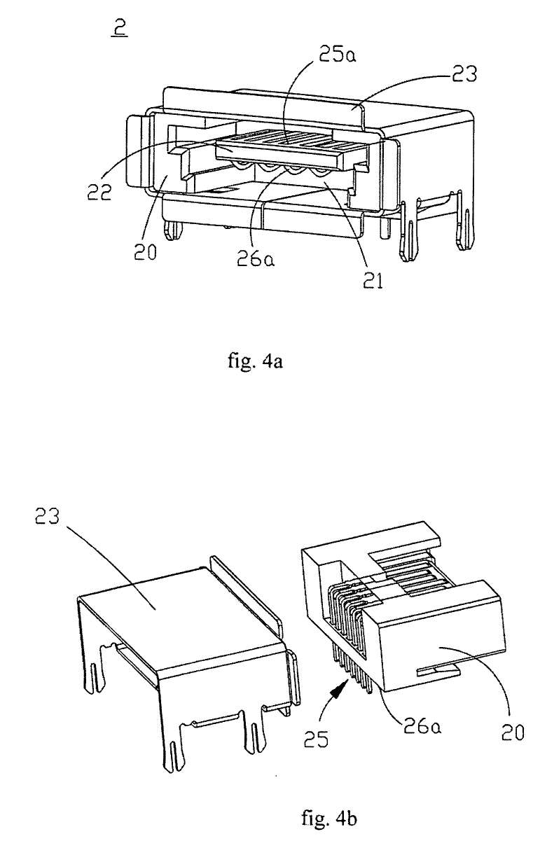

Referring to FIGS. 4A and 4B, the slot 2 comprises a hollow casing 20, a slot 21, a positioning set 22, a housing 23, a plurality of eSATA terminals 25a and a plurality of USB terminals 26a.

The hollow casing 20 comprises a slot 21, and the slot 21 comprises a positioning set 22. The slot 21 comprises an eSATA terminal set 25 comprising a plurality of eSATA terminals 25a and a USB terminal set 26 comprising a plurality of USB terminals 26 positioned respectively on the upper and the lower side. A housing 23 formed by a stamping process surrounds the hollow casing 20.

Referring to FIG. 3A to 4B, the hollow casing 10 comprises fool-proof protrusion positioned in front of the stair-case portion 13 coordinating with the stair-case portion 13 on the two side of the hollow casing 10. Thus, assembly error due to non-alignment during assembling the connector assembly 1 and the adaptor 2 may be effectively reduced.

The connector assembly 1 comprises a slot 14 at the central region of which comprises a plurality of flexible hook terminals connecting with the eSATA terminal set 15, and a plurality of fixed flat terminals connecting with the USB terminal set 16. Furthermore, the eSATA terminal set 25 connected to the upper part of the positioning set 22 of the adaptor 2 comprises a fixed flat terminal electrical connecting to the eSATA terminal set 15 of the connector assembly 1. The USB terminal set 26 connected to the lower part of the positioning set 22 of the adaptor 2 comprises flexible hook terminals corresponding to the USB terminal set 16 of the connector assembly 1 for reliable electrical connection.

After assembling the connector assembly 1 and the adaptor 2, the housing 12 connecting to the connector assembly 1 comprises contact with the housing 23 of the adaptor 2 for grounding.

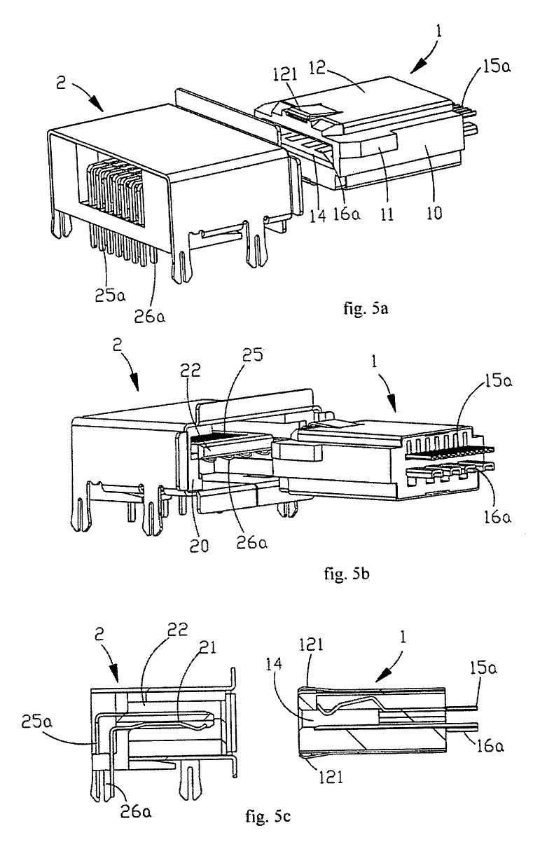

FIGS. 5A and 5B show exploded views of the assembly from another angle according to an embodiment of the present invention. The eSATA terminal set 15 is connected to the connector assembly 1 above the slot 14 in the hollow casing 10, comprises a plurality of flexible hook eSATA terminals 15a. The USB terminal set 16 is connected to the connector assembly 1 underneath the slot 14 in the hollow casing 10, and comprises a plurality of fixed flat USB terminals 16a. Thus, electronic connection between the connector assembly 1 and the adaptor 2 can be established.

FIG. 5C shows a sectional side view of an assembly according to an embodiment of the present invention. The plurality of flat USB terminals 16a and the plurality of hook eSATA terminals 15a have different specifications and are positioned regularly within the hollow casing 10. The electrical connecting end is formed respectively at the upper and the lower portion in the slot 14, and the terminal set like the eSATA terminal set 15 and the USB terminal set 16 can be varied upon the selected transmission protocol.

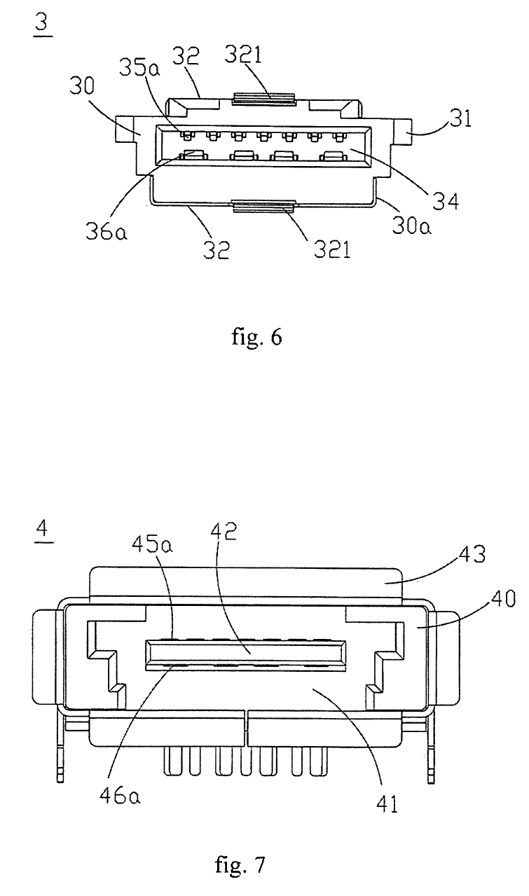

FIGS. 6 and 7 show prospective views of a connector assembly and an adaptor according to another embodiment of the present invention. The connector assembly 3 comprises a hollow casing 30, two fool proof protrusions 31, a housing 32, two stair-case portion 33, a slot 34, a plurality of eSATA terminals 35a and a plurality of USB terminals 36a. The hollow casing 30 comprises fool proof protrusion 31 positioning respectively formed on the right and the left side thereof, a housing 32 surrounding the hollow casing 30, wherein the housing 32 comprises elastic plates 321 positioned respectively on the upper and the lower side thereof.

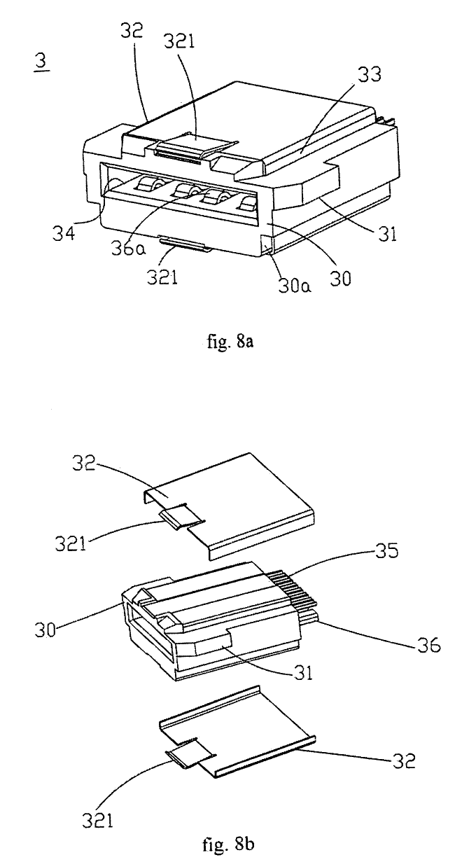

Referring to FIG. 8B, the housing 32 is comprised of a metallic case formed by a stamping process. In the present embodiment, the housing 32 is made of a metallic material, and hollow casing 30 can be completely covered by the housing 32, or partially disposed on the upper and the lower end or the right and the left sides.

The adaptor 4 comprises a hollow casing 40, a slot 41, a positioning set 42, a housing 43, a plurality of eSATA terminals 45a and a plurality of USB terminals 46a.

The connector assembly comprises a slot 34 at the central region of the hollow casing 30 thereof, an eSATA terminal set 35 comprising a plurality of eSATA terminals 35a is connected to the slot 34 at the upper side thereof; a USB terminal set 36 comprising a plurality of USB terminals 36a is connected to the slot 34 at the lower side corresponding to the eSATA terminal set 35. The hollow casing 40 comprises a slot 41 having a positioning set 42. The positioning set 42 comprises an eSATA terminal set 45 comprising a plurality of eSATA terminals 45a and a USB terminal set 46 comprising a plurality of USB terminals 46a respectively positioned at the upper and the lower side thereof.

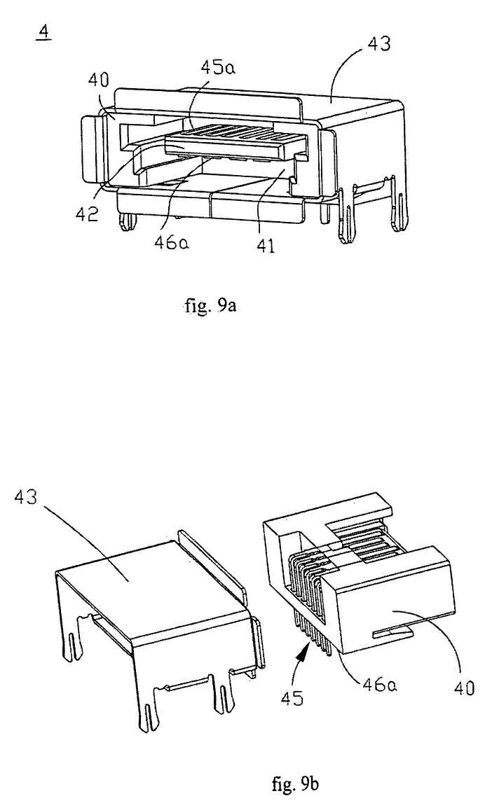

FIG. 8A to 9B show an elevational views and an exploded views of a connector assembly and an adaptor according to another embodiment of the present invention. The hollow casing 30 comprises a fool proof case. The stair-case portions 33 is positioned on the two sides of the hollow casing and the fool proof protrusion 31 positioned at the frontal end of the stair-case portion 33 can coordinate to effectively prevent assembly error occurred during assembling the connector assembly 1 and the adaptor 2.

The connector assembly 3 connected to an eSATA terminal set 35 comprises a plurality of flexible hook-like terminals 35a at the central upper part of the slot 34; a USB terminal set 36 comprising a plurality of flexible hook-like USB terminals 36a have different specification compared to the corresponding eSATA terminal set 35.

The adaptor 4 connected to an eSATA terminal set 45 comprises a plurality of flexible flat terminals 45a at the upper part of the positioning set 42 corresponding to the eSATA terminal set 35 of the connector assembly 3; a USB terminal set 46 positioned underneath the positioning set 42 corresponding to the USB terminal set 36 of the connector assembly 3.

After assembling the connector assembly 3 and the adaptor 4, the housing 32 connected to the connector assembly 3 contacts with the housing 43 of the adaptor 4 for grounding.

According to another embodiment of the present invention, the hollow casing 30 comprises a positioning set 30a formed at the bottom portion. Thus, the assembly of the hollow casing 10 and the connector assembly with the adaptor can be easily accomplished.

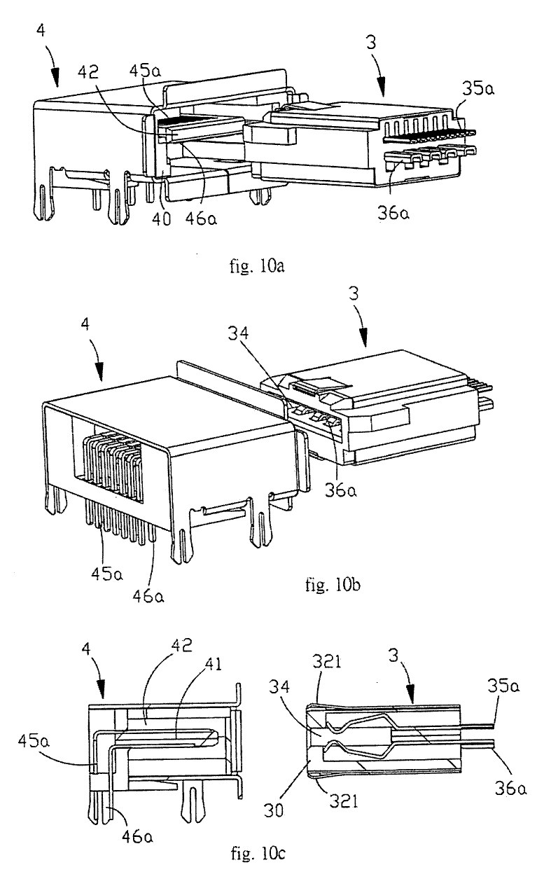

FIGS. 10A and 10B show exploded views of the assembly from another angle according to another embodiment of the present invention. The eSATA terminal set 35 is connected to the upper side within the central slot 34 of the hollow casing 30 of the connector assembly 3, and the USB terminal set 36 is connected to the lower part within the central slot 34 of the hollow casing 30 of the connector assembly 3; and the USB terminal set comprises a plurality of flexible hook-like USB terminals 36a having a specification different compared to the eSATA.

FIG. 10C shows a sectional side view of an assembly according to another embodiment of the present invention. The plurality of hook-like eSATA terminals 35a and the plurality of hook-like USB terminals 36a having specification different compared to the hook-like eSATA terminals 35a are positioned in the hollow casing 30 and respectively electrical connected at the upper and the lower part within the slot 34. The terminal set like the eSATA terminal set 35 and the USB terminal set 36 can be varied upon the selected transmission protocol.

The eSATA terminals 35a and the USB terminals 36a are two different types of flexible hook-like transmission terminals, and the hook-like shape enables the embodiment of the present invention to be applied in connector assemblys of various protocols.

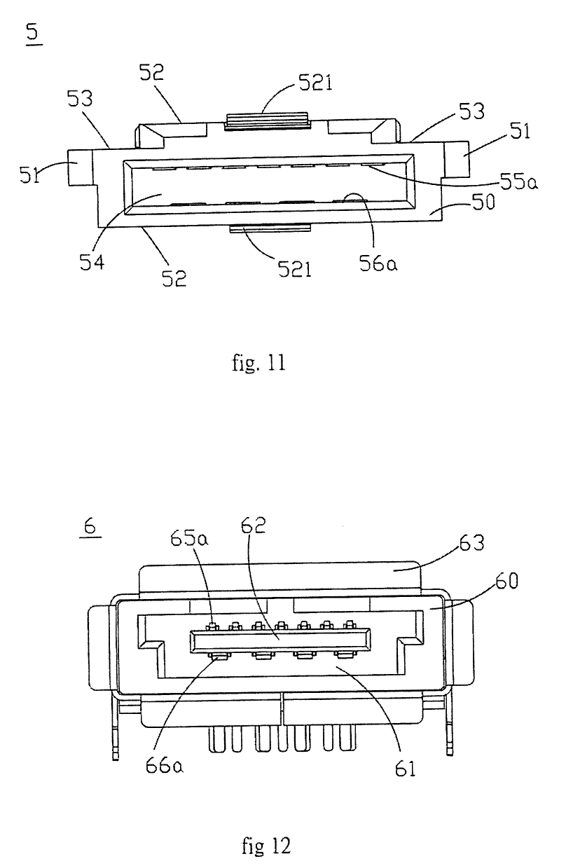

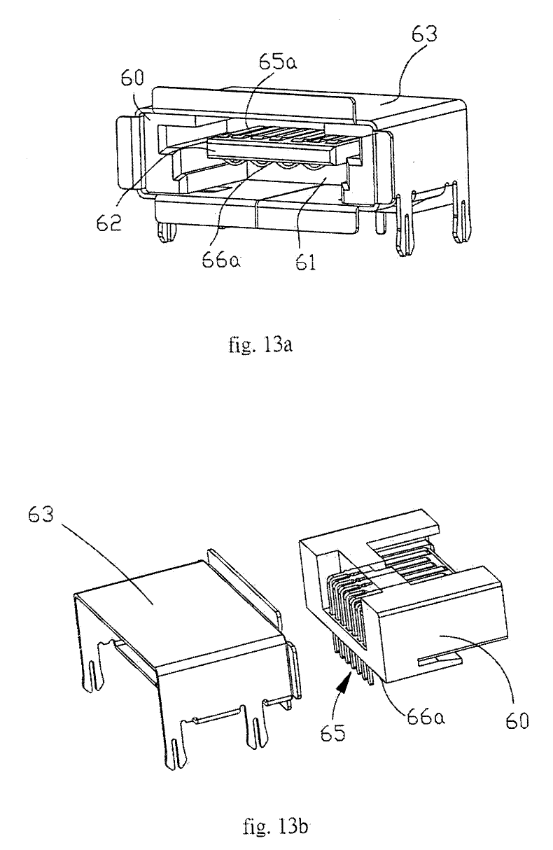

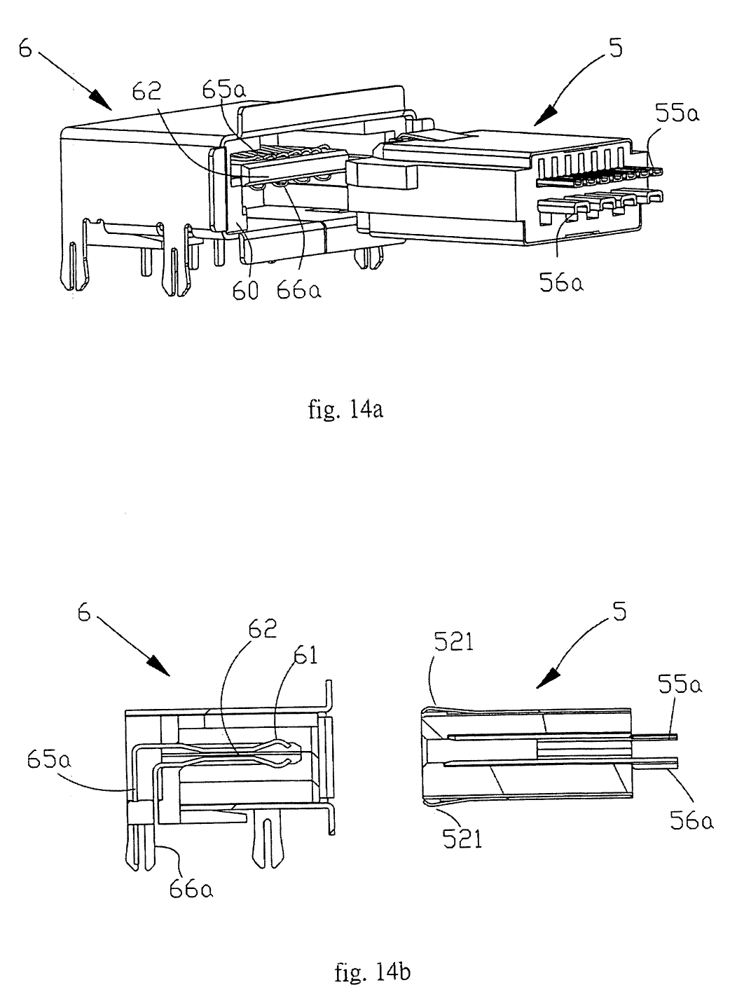

FIG. 11 to 14B show a prospective views and exploded views of a connector assembly and an adaptor according to yet another embodiment of the present invention. The connector assembly 5 comprises a hollow casing 50, two fool proof protrusions 51, a housing 52, two stair-case portion 53, a slot 54, a plurality of eSATA terminals 55a and a plurality of USB terminals 56a. The hollow casing 50 comprises a fool proof protrusion 51 positioned respectively on the right and the left side thereof; a housing 52 surrounding the hollow casing 50. The housing 52 comprises elastic plates 521 positioned respectively on the upper and the lower side.

Referring to FIG. 8B, the housing 52 is comprised of a metallic case formed by a stamping process. In the present embodiment, the housing 52 is made of a metallic material, and hollow casing 50 can be completely covered by the housing 52, or partially disposed on the upper and the lower end or the right and the left sides.

The adaptor 6 comprises a hollow casing 60, a slot 61, a positioning set 62, a housing 63, a plurality of eSATA terminals 65a and a plurality of USB terminals 66a.

The connector assembly 5 comprises a slot 54 at the central region connected to an eSATA terminal set 55 comprising a plurality fixed flat terminals; a USB terminal set 56 comprises a plurality of fixed terminals having different specification positioned corresponding to the eSATA terminal set 55. The adaptor 6 comprises a positioning set 62 connected to the eSATA terminal set 65, and the eSATA terminal set 65 comprises a plurality of flexible protruded terminals and can be electrically connected to the eSATA terminal set 55 of the connector assembly 5. The USB terminal set 66 connected to the lower part of the positioning set 62 of the adaptor 6 comprises a plurality of flexible protruded terminals and can be electrically connected to the USB terminal set 56 of the connector assembly 5.

The eSATA terminals 65a and the USB terminals 66a are two different types of flexible protruded transmission terminals, and the protruded shape enables the embodiment of the present invention to be applied in connector assemblys in various protocols.

According to the above description, the present invention comprises at least the following advantages.
1. One single device comprises two different types of terminals, and the protruding hook type terminals can effectively enable the connector assembly to be applied in various protocols with other adaptor for signal transmission by different types of terminal sets;
2. The single connector assembly and the adaptor provide two different types of transmission protocols to effectively simplify the structure, and reduce the space occupation and also reduce the manufacturing cost, as well as increase the convenience.
3. The fool proof design in the casing can effectively prevent assembly error occurred during assembling the connector assembly and the adaptor.

While the invention comprises been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A connector assembly, suitable for an adaptor for applying in various protocols, comprising:
a hollow case, having two fool proof protrusions;
a housing, covering said hollow case and having two elastic plates; and
two terminal sets, connecting to an internal upper and lower parts of said hollow casing, for an electrical connection.

2. The connector assembly, suitable for an adaptor for applying in various protocols according to claim 1, wherein said hollow casing comprises a hollow case made of one-piece of a plastic material.

3. The connector assembly, suitable for an adaptor for applying in various protocols according to claim 1, wherein said housing comprises a case formed by a stamping process.

4. The connector assembly, suitable for an adaptor for applying in various protocols according to claim 1, wherein one of said two terminal sets connecting within said housing comprises a plurality of fixed flat terminals, and the other terminal set comprises a plurality of flexible hook-like terminals.

5. The connector assembly, suitable for an adaptor for applying in various protocols according to claim 1, wherein said two terminal sets connected within said housing comprise flexible hook-like terminals.

6. The connector assembly, suitable for an adaptor for applying in various protocols according to claim 1, wherein said two terminal sets connected within said housing comprise fixed flat terminals.

7. The connector assembly, suitable for an adaptor for applying in various protocols according to claim 1, wherein said two terminal sets respectively comprise a plurality of eSATA terminals serving as an eSATA terminal set, and a plurality of USB terminals serving as a USB terminal set.

8. The connector assembly, suitable for an adaptor for applying in various protocols according to claim 1, wherein said hollow casing comprises fool proof protrusions positioned respectively on two sides thereof.

9. The connector assembly, suitable for an adaptor for applying in various protocols according to claim 1, wherein said housing comprises elastic plates positioned respectively on an upper and a lower side thereof.

10. The connector assembly, suitable for an adaptor for applying in various protocols according to claim 1, wherein said hollow casing comprises a positioning set at a bottom thereof.

11. An adaptor, suitable for a connector assembly for applying in various protocols, comprising a hollow casing having a slot with a positioning set and covered by a housing, wherein said positioning set comprises a plurality of terminal sets respectively positioned at two sides thereof.

12. The adaptor, suitable for a connector assembly for applying in various protocols according to claim 11, wherein one of said terminal sets of said positioning set comprises a plurality of flexible hook-like terminals, and the other terminal sets of said positioning set comprises a plurality of fixed flat terminals.

13. The adaptor, suitable for a connector assembly for applying in various protocols according to claim 11, wherein said terminal sets of said positioning set comprise a plurality of comprise a plurality of fixed flat terminals.

14. The adaptor, suitable for a connector assembly for applying in various protocols according to claim 11, wherein said terminal sets of said positioning set comprise flexible hook-like terminals.

15. The adaptor, suitable for a connector assembly for applying in various protocols according to claim 11, wherein said two terminal sets are respectively comprise a plurality of eSATA terminals serving as an eSATA terminal set, and a plurality of USB terminals serving as a USB terminal set.
